(19) United States
(12) Patent Application Publication
(10) Pub. No.: US 2005/0202146 A1
(43) Pub. Date: Sep. 15, 2005

(54) Water beverage containing fibres

(75) Inventors: Helen Gillian Anantharaman, Servion (CH); Christopher John Burton Brimelow, Shanghai (CN); Gene Frank Clyde, Shanghai (CN); Jean-Pierre Dawance, Shanghai-Podong (CN); Marc Laupie, Nomexy (FR); Tjin Dewi Narotski, Shanghai (CN); Werner Schuppisser, Niderglatt (CH); Weijian Wu, Shanghai (CN)

Correspondence Address: BELL, BOYD & LLOYD LLC, P. O. BOX 1135, CHICAGO, IL, 60690-1135, US

(73) Assignee: Nestec S.A., Vevey (CH)

(21) Appl. No.: 10/527,343

(22) PCT Filed: Sep. 9, 2003
(86) PCT No.: PCT/EP03/09999

§ 371 Date: Apr. 25, 2005

(30) Foreign Application Priority Data
Sep. 10, 2002 (EP) 02078735.4

(51) Int. Cl. C12C 1/00

(52) U.S. Cl. 426/590

(57) ABSTRACT

The present invention relates to a water-based beverage containing soluble fibres. The water composition is substantially demineralized and has a neutral or acidic pH. The soluble fibres contained in the present water composition are selected from a group comprising oligosaccharides with a chain length of from about 2 to 20 units and digestion-resistant malto-oligosaccharides with a Molecular Weight of about 2000. The present water composition may be store without adverse effect such as hydrolysis of oligosaccharides nor precipitation of the soluble fibres contained in it.

The present invention relates to a water-based beverage, which comprises soluble fibres without compromising shelf-stability, appearance, safety, taste as well as nutritional benefits.

### BACKGROUND OF THE INVENTION

Fibres have gained popularity among the past few years due to the large interest of both consumers and food companies for their acknowledged nutritional benefits.

Physiological features and nutritional benefits of fibres are broad. They are considered as having nutritional benefits on the control of glycaemia, on the metabolism of cholesterol and triglycerides, on the gut fermentation through gas production, on the control of the function of the gastro-intestinal tract and are considered as having a prebiotic effect on gut microflora.

Dietary fibres are considered to be the soluble and insoluble components of food that are not digested by enzymes in the human gastrointestinal tract. These fibres include non-starch polysaccharides, (from either vegetal, algae, bacterial or fugal origin) resistant starch as well as lignin and oligosaccharides.

Dietary fibres covers a wide variety of compounds that share the feature of being substantially non digested by gastro-intestinal enzymes in the gut where they are more or less fermented by the local micro-flora.

All dietary fibres have not the same structure nor the same physico-chemical properties and therefore provide different health benefits. Insoluble dietary fibres, such as cellulose and hemicellulose, are excellent for decreasing the transit time of food through the digestive tract. On the other hand some soluble and very viscous fibres like guar gum and β-glucans have effect on glycaemia and some non-viscous ones like fructo-oligosaccharides have positive impact on gut fermentation as well as on microflora development.

The primary source of dietary fibres is found in vegetables and cereal products. However nowadays, due to the increase of the consumption of processed-foods, the average daily intake of fibres is decreasing. Therefore there is a trend to complement processed foods with added fibres, whether soluble and/or insoluble. However, supplementation with fibres leads sometime to the problem of imparting a somehow gritty taste to the concerned food products.

Regarding beverages field, some attempts have been done to supplement beverages with fibres. Such beverage may comprise soluble or insoluble fibres and are often in the form of medicinal feeding beverage supplemented with sugar, dies as well as flavouring and aromas where fibres are suspended and/or dissolved in the liquid phase.

Regarding the supplementation of beverages with fibres, it is not really conceivable to use either viscous or insoluble fibres. Some attempts have been made in order to supplement beverages like soft drinks and clear beverages with soluble fibres. U.S. Pat. No. 5,851,578 describes a liquid beverage with soluble fibre added which is buffered with food acids. The beverage is pasteurised. Indeed, since fibres may be fermented by microorganisms like bacteria moulds and fungi, acidification is necessary to prevent fermentation and ensure good shelf-stability. This patent also teaches how to prepare a powder granular mix of the ingredients intended for the reconstitution of the said beverage.

However, if the acidification of the beverage can be considered as a good solution to minimize the risks of spoilage, some soluble fibres may undergo hydrolysis into simple sugar under such acidic conditions.

According to prior art the supplementation of fibres to beverage is better to be done just before consumption in order to avoid either spoilage or hydrolysis of soluble fibres.

U.S. Pat. No. 6,248,390 discloses a water containing fibre. This patent describes the manufacture of such beverage by dissolving the fibres into water and also teaches that the resulting solution may be autoclaved in order to ensure microbial status. However, there are no trials presented in such document referring to autoclaving of such solutions. Indeed, it is suspected that such drastic heat treatment may involve partial hydrolysis of soluble fibres as well as an increase in the Optical Density of the solution. Moreover, currently most of the packaging materials suitable for bottled water are made of plastic such as PET and are not resistant to autoclaving where temperatures above 100° C. are applied.

Therefore there remains a need for a clear beverage that contains soluble fibres which does not undergo hydrolysis, that is shelf-stable and that does not compromise taste, mouthfeel and appearance.

### SUMMARY OF THE INVENTION

Accordingly, the present invention is directed to a shelf-stable, clear and neutral pH water composition comprising water and soluble fibres wherein the water is substantially demineralized and the soluble fibres comprise oligosaccharides with a chain length of about 2 to 20 units.

Surprisingly, it has been observed that the addition of fibres comprising oligosaccharides with a chain length of about 2 to 20 units, preferably 2 to 15 units and more preferable 2 to 8 units allows to obtain a clear water beverage without the drawbacks of the prior products. Chain length is also known as degree of polymerization, DP.

Additional features and advantages of the present invention are described in, and will be apparent from, the following Detailed Description of the Invention.

### DETAILED DESCRIPTION OF THE INVENTION

The present invention provides that a shelf-stable, clear and neutral pH water composition comprising water and soluble fibres wherein the water is substantially demineralized and the soluble fibres comprise oligosaccharides with a chain length of about 2 to 20 units.

Suitable oligosaccharides may be chosen in the group comprising fructo-oligosaccharides made of fructose residues linked by β (2-1) bonds. The preferred fruto-oligosacchrides exhibit a chain length of around 2 to 20 fructose units, preferably 2 to 15 units and more preferably 2 to 8 fructose units.

The quantity of fibres contained in the water composition according to the present invention ranges from 0.1 to 10 gram of fibre per litre of water, preferably from 1 to 7 g/l and more preferably from 2 to 5 g/l.

The expression “neutral pH” means that the water composition according to the present invention has a pH ranging from about 5.5 to 8.5, preferably from about 6.5 to 7.5.

While neutral pH is sometimes desirable, in order to fit the taste of a whole range of consumers, beverages with an acidic pH in the range of about pH 4 to about pH 5 may be encompassed. However, as mentioned above, the stability of soluble fibres in solution in acidic medium is very critical and the use of oligosaccharides with a chain length of about 2 to 20 units is not possible because such fibre would undergo rapid hydrolysis thus losing the physiological benefits of such compounds. There remain a need for a water-based beverage that exhibits an acidic pH while containing soluble fibres that remain stable, i.e. not hydrolysed, during long-term storage.

Therefore it is also an other object of the present invention concerns a shelf-stable, clear and acidic pH water composition comprising water and soluble fibres that is characterized by the fact that:
the water may be substantially demineralised or mineralised,
and the soluble fibres comprise digestion-resistant malto-oligosaccharides with a Molecular Weight of about 2000.

Maltodextrin results from starch hydrolysis and is a product generally having a Dextrose Equivalent [DE] between 1 and 20 usually produced by the action of α-amylase on gelatinised starch. The commercial product is usually supplied as a free flowing spray-dried powder. Malto-oligosaccharide is an oligosaccharide containing up to about 10 anhydroglucose units and is found in maltodextrins with high degree of hydrolysis. In the context of the present invention concerning acidic water-beverage in which fructo-oligosaccharide hydrolysis may be an issue, suitable digestion-resistant malto-oligosaccharides with a Molecular Weight of about 2000 may be selected from Fibresol® maltodextrin. This product is available on the market from Matsutani Chemical Industry Co., Ltd, Japan. Such a compound comprises about 9 to 12 glucose units and is usually derived from starch that has undergone physical, chemical and enzymatic treatment to render the resultant malto-oligosaccharide indigestible by human enzymes. More specifically corn starch may be treated by dry heat to a temperature of about 160° C. in the presence of hydrochloric acid (<0.15%) and subsequently may be treated with amylolytic enzymes (alpha-amylase and glucoamylase). The non-digestible dextrin produced may then be separated from the residual enzymes, liberated glucose and low molecular weigh by-products by treatment with activated carbon and fractionation on ion-exchange columns.

It has thus been observed that the use of digestion-resistant malto-oligosaccharides such as Fibresol® for example allows to obtain a water composition with acidic taste that may correspond to a specific consumer expectation and product range while avoiding the hydrolysis of these fibre components thus preserving the health benefit.

Indeed, an acidic taste, which usually corresponds to a pH range of about 4 to about 5, may particularly fit with water beverages containing additional flavours such as vegetal, herbal and fruity ones for example. In fact, fruits and vegetal in general are usually acid and a basic solving medium does not fit on the taste point of view.

Also, the expression “substantially demineralized” means, in the present context, that the water composition according to the present invention has a mineral level of less than about 400 PPM, preferably less than 200 PPM, more preferably less than 100 PPM and even more preferably from about 40 to about 70 PPM.

In the present context, the expression “shelf-stable” means that the water composition according to the present invention can be stored whether at ambient, cold or high (around 37° C.) temperature without microbial spoilage, degradation of the oligosaccharides, development of turbidity nor precipitation of the oligosaccharides, even for long time storage like months.

On the one hand, under such neutral pH conditions no oligosaccharide chain hydrolysis occurs and all the nutritional benefits of these fibres are kept. On the other hand, the use of digestion-resistant malto-oligosaccharides with a Molecular Weight of about 2000 allows the manufacture of acidic pH compositions with out loss of health benefit because of chain hydrolysis. The fibres that are contained in the present water compositions can thus be delivered to the gut microflora without prior hydrolysis and can therefore provide their prebiotic effect.

Since the consumption of water is also appreciated chilled it is convenient to store the present water composition at temperature of about 5° C. Interestingly, the water composition according to the present invention containing fibres may be store at such refrigeration temperatures and no precipitation of the dissolved fibre occurs. Such advantage is very interesting because such precipitation would be a definitive drawback regarding consumer acceptance.

Moreover, since the oligosaccharides do not undergo hydrolysis, they do not lead to the formation of simple sugars that could alter too much the neutral taste of the composition. However, it can be noticed that the addition of such fibres to water appears to be a convenient way to modify the bitterness, the sweetness, the softness, the astringency, the smoothness and metallic-ness of the water in a way that increases substantially its taste acceptability by consumers. In fact, the selected fibres do exhibit a kind of very slight sweet taste that can contribute to improve the taste of the beverage without increase the caloric value. Indeed, one drawback of low-mineral and demineralized waters is their taste, which is somehow perceived as bland and/or astringent. Moreover, in the case of water-beverage containing aroma, flavours, extracts or any other solute, it is highly desirable to soften the strength of some of them. Thus, the addition of the selected fibres to low mineral water according to the present invention appears as a good means for providing a great tasting water that is smooth and not astringent and has only just a hint of sweetness.

Accordingly, the present invention also concerns a method for modifying the bitterness, the sweetness, the softness, the astringency, the smoothness as well as the metallic-ness of a neutral or acidic pH and substantially demineralized water by the incorporation of soluble fibres selected in the group comprising oligosaccharides with a chain length of about 2 to 20 units and digestion-resistant malto-oligosaccharides with a Molecular Weight of about 2000.

As regards to suitable oligosaccharides for neutral pH water compositions according to one aspect of the present invention, these may be chosen in the group comprising fructo-oligosaccharides made of fructose residues linked by β (2-1) bonds. The preferred fructo-oligosaccharides exhibit a chain length of around 2 to 20 fructose units, preferably 2 to 15 units and more preferably 2 to 8 fructose units.

Regarding appearance of the water composition according to the present invention it is to be noticed that this water remains clear and translucent upon storage. Indeed, the specific choice of oligosaccharides with a chain length comprised between 2 and 20 units or digestion-resistant malto-oligosaccharides with a Molecular Weight of about 2000 allows avoiding any precipitation during storage.

In spite of the fact that the present water composition is intended to be substantially demineralized for purpose of taste, it may also be supplemented with minerals since it has been surprisingly found that the somehow gritty and metallic taste of added minerals observed in mineral-enriched water may be masked by the use of the fibres according to the different aspects of present invention. Suitable minerals may be selected from the group comprising Ca, Mg, Zn or Fe. As mentioned above, the slight sweet taste of both source of fibre allows this hint of sweetness that perfectly fit with the desired use.

Mineral supplementation of the water composition according to the present invention may be achieved by addition of a metastable Calcium Lactate-Citrate or Calcium-Magnesium Lactate-Citrate complex as described in U.S. Pat. No. 6,261,610 whose content is hereby incorporated by mean of reference.

According to consumer preference, the water composition according to the present invention may be supplemented with a whole range of functional ingredients that might include vitamins, antioxidants, plants extracts and flavors such as camomile, tilleul, orange flower or guarurana for example.

Different plants and vegetal extracts are known for their physiological effect for modulating biological functions. Among different physiological functions that may be modulated by plants extract one can cite modulation of blood pressure, increase of fat oxidation, release of stress, increase of digestion effectiveness, mental stimulation, increase of alertness, limitation of free-radicals and skin replenishment for example. Currently, many oral supplements are available on the market in the form of pills, tablets or herbal preparation for infusion for example. On the one hand, tablets and pills are not well perceived by the consumer since they are regarded as non natural and are too similar to drugs. On the other hand herbal preparation for herb-teas need cumbersome preparation and the taste of the products obtained thereof is not satisfactory. Indeed, herb-teas made with effective plant and vegetal extracts are often bitter and involve addition of significant amounts of sugar which is not always desirable.

There remains a need for food product that provides the benefit of physiological functions modulation through plant extracts but without the drawbacks of the existing products. Moreover, solid food products usually need to be dissolved and/or emulsified in order to cross gut barrier. Therefore a water-based beverage that would provide all the above mentioned benefits would also be much effective in the sense of bioavailability.

The present invention therefore concerns a beverage according to claim . . . that also comprise plant extracts selected in the group comprising: aloe vera, blueberry, caffeine, vitamin C, chrysanthemum, green tea guarana hawthorn, and honey, used alone or in combination.

The selection of the above mentioned ingredients allows to deliver the following benefits:
improvement of heart function and circulation and improvement of oxygen delivering through the blood for the oxidation process
enhancement of lipolysis or fat breakdown in combination with powerful antioxidants that will protect the body from damage as fat is broken down
alleviate gastrointestinal dysfunction and associated diarrhea.

More generally, the present invention concerns the use of water-based beverage according to claim . . . that allows an increased mental alertness with the consumer thanks to the addition of at least one stimulant and at least one blood circulating increasing agent. Suitable blood circulating increasing agent may be selected in the group comprising hawthorn and blueberry.

The present invention also concerns the use of water-based beverage according to claim . . . for improving skin health and skin elasticity thanks to the addition of skin rejuvenant and skin strengthening ingredient such as aloe vera extract and/or vitamin C. In the last case, the combination of selected fibre with aloe vera allows a synergistic effect of both ingredients in the sense that the fibres improve the absorption of aloe vera extract thus acting from the inside and not only topically as known from prior art.

Accordingly, the present invention also concerns the use of soluble fibres comprising oligosaccharides with a chain length of about 2 to 20 units for modifying the bitterness, the sweetness, the softness, the astringency, the smoothness as well as the metallic-ness of a neutral pH mineral-enriched water.

According to an other embodiment, the present invention concerns the use of soluble fibres comprising digestion-resistant malto-oligosaccharides with a Molecular Weight of about 2000 for modifying the bitterness, the sweetness, the softness, the astringency, the smoothness as well as the metallic-ness of an acidic pH mineral-enriched water.

Due to the high stability of the fibres contained in the water compositions according to the present invention, all the benefits of soluble fibres can be delivered to consumers in a simple, direct and convenient way, i.e. by simply opening a bottle of the water according to the present invention and drinking said water composition. Such bottled water is able to be stored at ambient temperature for a long time without adverse effects on the intrinsic properties and benefits that are delivered by the contained fibres.

Indeed, the present water composition, through delivering of fibres presents a means to deliver all the nutritional benefits of fibres, namely:
improvement and increase of intestinal microflora (especially Bifidobacterium),
short chain fatty acids production through fermentation of the fibres by the intestinal microflora,
increase of faecal volume as well as faecal frequencies,
moderation of post-prandial rise in blood glucose level for healthy human subjects (when the water consumption is associated with ingestion of a meal or a snack for example),
prevention of intestinal mucosal atrophy in case of long-term enteral nutrition,
favourable effects on serum cholesterol and triglycerides levels.

In order to manufacture the water composition according to the present invention without compromising the nutritional benefit of fibres and in order to ensure complete shelf-stability of the product, a soft manufacturing process may be achieved.

Such manufacturing process may comprise the following steps:
providing a syrup comprising from 10 to 30% by weight of soluble fibres in water,
filtering the said obtained syrup through a filter with a pore size sufficiently small to exclude at least 99.9% of the bacteria, fungi, molds and spores,
providing a neutral or acidic pH and substantially demineralized or mineralized water,
filtering the said water through a filter with pore size sufficiently small to exclude about 99.9 of the bacteria, fungi, molds and spores,
treating the filtered water with Ozone in order to reduce the total microflora to about 0 cfu/ml (colony forming unit/ml) of water,
mixing the filtered and ozonated water with the filtered syrup under aseptic condition in order to obtain the water composition according to the present invention,
filling sterile bottles with the water composition in an ultra clean environment.

The filtration of both syrup and water may be achieved by means known by the skilled in the art, through membrane filter with pore size of around 0.2 to 0.5 μm, for example.

The ozonation of water may be achieved by bubbling ozone into the water in order to reach a level of about 0.1 to 1 PPM ozone.

A sterile filling may be achieved using plastic bottles and caps that are sterilized prior to filling whether by ozonation or thanks to H₂O₂, for example. The filling takes place in an ultra clean environment.

Alternately the product may be manufactured using an ultra high temperature process to sterilize the materials and subsequently filling under aseptic conditions.

### EXAMPLE 1

### Manufacture of Water Composition with Oligofructosaccharides

A Sterile Syrup is Prepared According to the Following Procedure:

A concentrated oligofructose syrup with an average degree of polymerization of 10 (10 fructose units) is dissolved in water in order to obtain two syrups containing 15 and 30% by weight of oligofructose. The thus obtained syrups are filtered through a membrane-filter equipped with 0.2 μm pores.

The sterilization of the syrups is checked by total aerobic microflora count and table 1 shows a complete elimination of viable microflora.

TABLE 1
Microbial counts of filtrated oligofructose syrup.

| | Before Filtration | After Filtration |
|---|---|---|
| Water Samples | (cfu/ml) | (cfu/ml) |
| 30% oligofructose - DP 10 | 164 | 0 |
| 15% oligofructose - DP 10 | 17 | 0 |

Sterile Water is Prepared According to the Following Procedure:

Water with a mineral content of 75 PPM and a pH of 6.5 is filtered through a 0.2 μm pores membrane filter.

The filtered water is then ozonated by bubbling ozone gas into it in order to dissolve 0.8-1.0 PPM ozone in the water and obtain a final ozone content in finished product of a minimum of 0.2 PPM immediately following filling.

Then, both sterile mixtures (syrup and water) are mixed in line under sterile condition and filled in an ultra clean environment (minimum class 100 conditions) or aseptically to obtain a final concentration of fibres (oligosaccharides) of 4 g/l.

The bottles may be stored for several weeks even months without microbial development, without off-taste apparition, no oligossaccharide hydrolysis nor appearance of any coloration. Alternatively, the bottled water containing fibres may also be stored at refrigeration temperature and no precipitation of the dissolved fibre occurs.

### EXAMPLE 2

### Organoleptic Assessment of the Water Containing Fibre

A panel of 22 consumers in the age group of 25-60 was asked to rate the taste, smell and appearance of the following water compositions:

Water composition according to example 1 stored at different temperature versus low mineral spring water. The results of the test are showed in Table 2.

It is clear that the water composition according to the present invention is highly preferred compared to classical spring water.

It can be noticed that for both cases, the differences between the samples are clearly perceived and the organoleptic descriptors used for differentiating the products are very positive. The water composition according to the present invention has an improved taste being smoother and not perceived as astringent compared to the spring water.

TABLE 2
Consumer acceptance and organoleptic features
of the composition according to the invention.

| Group 1 | Water sample | milky, a little bit | 21 of 22 | the two |
|---|---|---|---|---|
| | of example 1 | sweet, fruity, taste | person can | products are |
| | kept at room | perceived, little | feel the | different at |
| | temperature | flavor of cameral, | difference | 0.1% level |
| | | mouthfeel is round | | |
| | | & soft, yoghurt taste | | |
| | low mineral | sweet, neutral, bitter, a little bit Sour, | | |
| | spring water | astringent, metallic, aftertaste is bitter | | |
| Group 2 | water sample | sweet, milky, fruity, | 17 of 22 | the two |
| | of example 1 | cameral, aroma is | person can | products are |
| | kept in 37° C. | like candy, sweet, | feel the | different at |
| | | chlorine, yoghurt | difference | 5% level |
| | | taste, maybe not | | |
| | | fresh | | |

| | |
|---|---|
| low mineral | bitter, neutral, fermented, slight mouldy flavor, |
| spring water | normal |

Subsequently larger scale trials were conducted with more than 200 consumers and the product was preferred 65:35 against a low mineralized water.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. Shelf-stable, clear and neutral pH water composition comprising water and soluble fibres that is characterized by the fact that:
the water is substantially demineralized
and the soluble fibres comprise oligosaccharides with a chain length of about 2 to 20 units.

2. Water composition according to claim 1, characterized in that oligosaccharides are chosen in the group comprising fructo-oligosaccharides made of fructose residues linked by β(2-1) bonds.

3. Water composition according to claim 1, characterized in that the fibres quantity contained in the water composition ranges from 0.1 to 10 grams of fibres per litre of water.

4. Method for modifying the bitterness, the sweetness, the softness, the astringency, the smoothness as well as the metallic-ness of a neutral pH and substantially demineralized water by the incorporation of soluble fibres comprising oligosaccharides with a chain length of about 2 to 20 units.

5. Use of soluble fibres comprising oligosaccharides with a chain length of about 2 to 20 units for modifying the bitterness, the sweetness, the softness, the astringency, the smoothness as well as the metallic-ness of a neutral pH mineral-enriched water.

6. Shelf-stable, clear and acidic pH water composition comprising water and soluble fibres that is characterized by the fact that:
the soluble fibres comprise digestion-resistant malto-oligosaccharides with a Molecular Weight of about 2000.

7. Composition according to claim 6, further comprising at least one ingredient selected in the group comprising: vegetal extract, herbal and fruity extract used alone or in combination.

8. Use of a composition according to claim 7, for effecting at least one of the following physiological modulations: modulation of blood pressure, increase of fat oxidation, release of stress, increase of digestion effectiveness, mental stimulation, increase of alertness, limitation of free-radicals and skin replenishment.
